(19) United States
(12) Patent Application Publication
(10) Pub. No.: US 2024/0258628 A1
(43) Pub. Date: Aug. 1, 2024

(54) BATTERY PACK ENCLOSURE

(71) Applicant: Cummins Inc., Columbus, IN (US)

(72) Inventors: Nicholas Reyne Milanovic, Columbus, IN (US); Peter Sexton, Columbus, IN (US); Vishnu Eswaran, Columbus, IN (US); Ian Newnham, Columbus, IN (US)

(21) Appl. No.: 18/424,211

(22) Filed: Jan. 26, 2024

Related U.S. Application Data
(60) Provisional application No. 63/442,192, filed on Jan. 31, 2023.

(51) Int. Cl. H01M 50/258; H01M 50/249; H01M 50/262

(52) U.S. Cl. CPC H01M 50/258; H01M 50/262; H01M 50/249; H01M 2220/20

(57) ABSTRACT

A battery pack enclosure for a battery pack comprising a plurality of battery cells is disclosed. The battery pack enclosure comprises a top panel, a bottom panel, and a plurality of surround frames. Each surround frame is arranged to support a plurality of battery cells. The surround frames are stacked, and a seal is provided between two adjacent surround frames. This may allow battery pack capacity to be increased using minimal bolted joints to retain structural rigidity and sealing while maximizing energy density, serviceability and production efficiency.

### CROSS REFERENCE TO RELATED APPLICATIONS

The present application claims the benefit of U.S. Provisional Patent Application No. 63/442,192, filed Jan. 31, 2023, which is incorporated herein by reference in its entirety.

### FIELD

The present disclosure relates to a battery pack enclosure for a battery pack comprising a plurality of battery cells, and to a corresponding battery pack. The present disclosure has particular but not exclusive application in battery packs for electric or hybrid electric vehicles.

### BACKGROUND

Electric vehicles and hybrid electric vehicles, such as cars (automobiles), buses, lorries, vans and trucks, typically use battery packs that are designed with a high ampere-hour capacity in order to give power over sustained periods of time. A battery pack comprises a large number of individual electrochemical cells connected in series and parallel to achieve the total voltage and current requirements. To assist in manufacturing, assembly and servicing, the cells in a battery pack may be grouped into modules, or they may be mounted directly in an enclosure to form a cell-to-pack arrangement. The modules or cells may include a support structure and a cell monitoring unit to monitor cell parameters such as state of function, voltage, temperature, etc. A battery management system may be provided in conjunction with the cell monitoring units to manage cell charge and discharge. The battery cells and battery management system together with other components of the battery pack are typically contained within a housing.

Known battery pack housings typically comprise a surround frame, a top panel and a bottom panel. The surround frame may be made from a metal such as aluminium and may provide the main structural part of the housing. The top panel and bottom panel may be formed from a sheet of material such as a metal or a composite. The top panel and the bottom panel are typically attached to the surround frame using a gasket and a plurality of bolts.

In order to increase battery capacity, it is known to stack a plurality of battery packs together. This typically requires the use of multiple fasteners to connect the packs together. However, this may create difficulties in maintaining structural strength due to vibration profiles and relaxation of the fasteners over time. Furthermore, such arrangements typically require a relatively large number of external connections to be made which may be cumbersome for the user. Such arrangements also may not fully optimise the available packaging space. For example, in the case of electric or hybrid electric vehicles, the available packaging space may be limited and/or predefined, and it may be desirable to optimise the energy density within the available space.

It would therefore be desirable to provide a battery pack design that can be expanded or shrunk depending on user requirements via the use of minimal bolted joints to retain structural rigidity and sealing while maximizing energy density, serviceability and production efficiency.

### SUMMARY

According to one aspect of the present disclosure there is provided a battery pack enclosure comprising:
a top panel;
a bottom panel; and
a plurality of surround frames, each surround frame arranged to support a plurality of battery cells,
wherein the surround frames are stacked, and
a seal is provided between two adjacent surround frames.

The present disclosure may provide the advantage that, by providing a plurality of stacked surround frames and a seal between two adjacent surround frames, it may be possible for battery pack capacity and/or voltage to be increased without the use of multiple single packs. This may be achieved using minimal bolted joints to retain structural rigidity and sealing while maximizing serviceability and production efficiency. The top panel, bottom panel and surround frame may form a single enclosure which may optimize space and energy density, reduce complexity, reduce the number of high-cost components and/or reduce the number of connections for the end user. This may be advantageous, particularly in vehicle applications where packaging space may be limited or predefined.

In one embodiment, the seal comprises a pressure sensitive adhesive. The pressure sensitive adhesive may set when compressed. This may allow a seal to be formed between the surround frames using a minimum number of fasteners, which may facilitate production and lower costs. Furthermore, use of a pressure sensitive adhesive may facilitate servicing of the battery pack.

In one embodiment, the seal is removeable while the surround frames are stacked. For example, the seal may be removable by pulling it away from the surround frames. This may facilitate servicing of the battery pack.

In one embodiment, the battery pack enclosure comprises a plurality of fasteners arranged to urge two adjacent surround frames together. The fasteners may be for example bolts, screws, clips, clamps or threaded rods. This may allow a pressure to be applied to the seal. Where the seal is a pressure sensitive adhesive, the pressure may be such as to cause the pressure sensitive adhesive to set. This may help to ensure that, in use, the enclosure is sealed.

The battery pack enclosure may be in any appropriate shape, such as a rectangular cuboid, and may comprise a plurality of corners (for example, four corners). In this case, a fastener (such as a bolt) may be provided at each corner of the battery pack enclosure. This may allow the fasteners to be substantially aligned with the walls of the surround frames. This may allow a force to be transferred from the fasteners through the walls of the surround frames to the seal without any significant deflection or bending of the walls. This may allow pressure to be applied to the seal using surround frames having relatively thin walls, which may allow the enclosure to be lightweight and cost effective.

In one embodiment, the two adjacent surround frames are connected without the use of multiple fasteners along each wall and/or without the use of peripheral flanges. For example, in one embodiment, the two adjacent surround frames are connected using a fastener at each corner and a pressure sensitive seal, without the use of multiple peripheral fasteners. Thus, the surround frames may be provided without outside flanges or peripheral bolted joints. This may allow a reduction in weight, volume and cost, and may facilitate production and servicing. The frame and component stiffness may be chosen to enable this.

In one embodiment, the surround frames are extruded. For example, the surround frames may be formed from extruded aluminium. This may allow a strong and lightweight surround frame to be produced using a readily available and inexpensive manufacturing process.

In one embodiment, each surround frame is formed from a single continuous piece of extruded material which is bent into shape. Thus, in one embodiment, each surround frame is formed from a single continuous bent extrusion. The extruded material may be bent into shape using, for example, stretch bending, CNC bending, push bending, draw bending, roller bending, compression bending, or any other appropriate type of bending. This may allow a strong and lightweight surround frame to be produced with a minimal number of joints. This in turn may minimize the risk of distortion which may be caused, for example, by welding multiple parts together, and/or reduce the areas in the battery pack enclosure that may be a leak risk as a result of material inhomogeneity. However, if desired, the surround frame could be formed from two or more pieces instead.

In one embodiment, each surround frame has the same shape. For example, each surround frame may have a rectangular profile (when viewed from above) or any other appropriate shape. This may allow each surround frame to be produced in the same way, which may facilitate manufacture and reduce cost.

The surround frames may comprise a plurality of walls. For example, each surround frame may have a rectangular profile (when viewed from above), in which case it may have four walls, such as a front wall, a rear wall and two side walls. However, each surround frame may be at least partially open on two sides, such as a top side and a bottom side. Thus, the surround frame may surround the battery cells, but not enclose them all sides. This may facilitate manufacture of the surround frames, for example, by extrusion. This may also allow the battery pack enclosure to be formed with a single cavity, which may help to optimize space and energy density. Furthermore, this may facilitate access to the battery cells, thereby facilitating servicing.

In one embodiment, each surround frame comprises a plurality of walls, and each wall comprises a top lip and a bottom lip. The top lip and the bottom lip may extend inwards (towards the interior of the enclosure) from the wall. For example, where the surround frame is formed from a continuous piece of extruded material, the extruded material may have a C-shape (or rotated U-shaped) cross section with an upright wall, a top lip and a bottom lip. In the assembled battery pack enclosure, the seal may be provided between the bottom lip of one surround frame and the top lip of the adjacent surround frame. This may help to minimise the external dimensions of the battery pack enclosure, thereby optimising space. Furthermore, this may facilitate production of the surround frames from continuous stretch bent extrusions.

The walls of one surround frame may be aligned (vertically) with the walls of an adjacent surround frame. This may facilitate the transfer of force through the walls of the surround frames to the seal without significant deflection or bending of the walls. For example, a force may be transferred from fasteners through the walls of the surround frames to the seal in order to apply pressure to the seal, as well as via shear capacity of the seal.

In one embodiment, the force may be such as to apply a pressure of at least 1000, 2000 or 5000 N/m² to the seal, although other values may be used instead.

Each wall of a surround frame may be connected to two adjacent walls at a corner. Thus, each corner may be at the interface of two adjacent walls. The two adjacent walls may be for example, at an angle of 90° to each other, or some other angle. The corners may be formed, for example, when a piece of extruded material is bent into shape (for example, into a rectangular shape) to form the surround frame.

In one embodiment, the surround frames comprise corner gussets. The corner gussets may be provided at each corner of the surround frames. The corner gussets may be attached to the surround frame using for example rivets, bonding, welding or any other appropriate technique. The corner gussets may have an L-shaped cross section (when viewed from above) and may extend around each corner of the surround frame. The corner gussets may help to provide stiffness to the surround frame and/or transfer load to vehicle mounting points. This may help to strengthen the surround frames and help them to retain their shape. This in turn may facilitate the use of surround frames formed from continuous stretch bent extrusions, by strengthening the surround frames where the extrusions have been bent.

The corner gussets may be arranged to receive fasteners which fasten the two adjacent surround frames together. For example, the corner gussets may comprise holes which may be arranged to receive bolts which pass through a corner gusset of one surround frame and into a corner gusset of an adjacent surround frame. Thus, the corner gussets may be arranged to receive fasteners which urge the two surround frames together. This may allow the surround frames themselves to be relatively thin, which may help to minimise weight, size and cost and may facilitate production by extrusion.

The corner gussets may transfer a force from the fasteners to the surround frames. The surround frames may then transfer the force to the seal. This may allow a force to be transferred through the walls of the surround frame to the seal without any significant deflection or bending of the walls. Where the seal comprises a pressure sensitive adhesive, this may help to ensure that the seal remains set when the battery pack enclosure is in use. In one embodiment, each surround frame comprises a plurality of cell support rails on which the battery cells can be mounted. For example, each surround frame may comprise two cell support rails, one on each side of the surround frame. The cell support rails may be provided inside the surround frame, for example, between a wall of the surround frame and a lower lip. Where the battery cells are packaged in modules, the battery modules may be mounted (directly or indirectly) on the cell support rails. Where the cells are not grouped in modules, the cells may be mounted (directly or indirectly) on the cell support rails. This may allow the battery pack to comprise a plurality of self-supporting tiers, which may facilitate configuration and assembly of the battery pack.

The battery cells and/or modules may be transverse mounted. For example, the surround frames may have a length, a width and a height, and the battery cells and/or modules may extend across the width of the surround frames, between two cell support rails. This may facilitate support of the battery cells and/or modules by the surround frames.

The cell support rails may extend substantially along a length of the surround frame. This may allow the cell support rails to help provide sectional stiffness to the surround frames, as well as supporting the battery cells and/or modules. This in turn may help to transfer force through the surround frames to the seal. Furthermore, the use of cell support rails may facilitate production of the surround frames from continuous stretch bent extrusions by stiffening the surround frames post-production.

In one embodiment, the top panel and bottom panel are attached to the surround frames with adhesive. By attaching the top panel to the surround frame using adhesive, it may be possible to reduce the contact area between the top panel and the surround frame. This may increase the size of the opening which is available for inserting battery cells and/or modules when the top panel is not attached, which may allow more efficient use of the space within the housing. Furthermore, this may be achieved without compromising structural integrity of the battery pack and/or the seal between the top panel and the frame. In addition, the use of adhesive can allow a continuous joint to be provided around the periphery of the surround frame, which may improve the shear transfer capacity and help to improve the torsional stiffness of the battery pack enclosure. As well as helping to provide load transfer, a continuous seal may also help with ingress protection. Furthermore, the use of adhesive may help to provide a more lightweight and cost-effective design, by avoiding the need for bolts and a gasket, reducing the size of or eliminating a flange on the surround frame and/or reducing the overall size of the surround frame.

According to another aspect of the disclosure there is provided a battery pack comprising:
a plurality of battery cells arranged in tiers; and
a battery pack enclosure, wherein the battery pack enclosure comprises:
   a top panel;
   a bottom panel; and
   a plurality of surround frames, each surround frame supporting a tier of battery cells,
wherein the surround frames are stacked, and
a seal is provided between two adjacent surround frames.

In one embodiment, each surround frame comprises a plurality of cell support rails and the battery cells are mounted on the cell support rails. This can allow each tier of the battery pack to be self-supporting, which may facilitate assembly and scalability. The cells may be grouped into battery modules, in which case the battery modules may be mounted on the cell support rails. Alternatively, the battery cells themselves may be mounted on the cell support rails.

In one embodiment, the battery pack further comprises at least one cross member running between two walls of each surround frame. In this case, the battery pack may further comprise at least one fastener (or a plurality of fasteners) which fastens cross members of adjacent tiers. This may help to urge adjacent surround frames together, thereby helping to ensure the integrity of the seal, while minimizing space requirements.

In one embodiment, the battery cells in one tier are electrically connected to the battery cells in another tier inside the battery pack enclosure. For example, in one embodiment, a positive terminal for the battery pack is provided in one tier and a negative terminal for the battery pack is provided in another tier and the battery cells in each tier are electrically connected (for example, in series) inside the battery pack enclosure. Alternatively, the positive and negative terminals could both be provided in one tier. In either case, this may reduce the number of components, such as connectors, contactors and fuses, which are required and reduce the number of connections which need to be made by the end user.

In one embodiment, each tier comprises at least one low voltage component, such as a cell monitoring unit and/or a battery management unit. In this case, a low voltage component in one tier may be electrically connected to a low voltage component in another tier inside the battery pack enclosure. This can allow a reduced number of low voltage terminals to be provided for the battery pack as a whole. This may reduce the number of external connectors which are required, which may reduce cost and reduce the number of connections which need to be made by the end user.

In one embodiment, each tier comprises one or more cell monitoring units. The cell monitoring units may be arranged to monitor cell parameters such as status, voltage, current, temperature, pressure etc. A battery management system may be provided in conjunction with the cell monitoring units to manage module cell charge and discharge.

In one embodiment, the battery pack comprises at least one battery management unit. For example, each tier may comprise a battery management unit. Alternatively, a battery management unit may be shared between two or more tiers. Since the battery management unit tends to be an expensive component, this may help to reduce the overall cost of the battery pack. The battery management unit may be provided inside the surround frame or outside the surround frame, or a combination of the two. If the battery management unit is outside the surround frame, the battery management unit may communicate with one or more cell monitoring units through a low voltage terminal on the surround frame. If the battery management unit is inside the surround frame, a low voltage terminal in the surround frame may be used to connect the battery management unit to an external part of the battery management system.

In one embodiment, each tier comprises at least one conduit for a cooling fluid. For example, each tier may comprise one or more cooling plates for cooling the battery cells. The cooling plates may be provided, for example, underneath the battery cells. The coolant plates may be arranged to allow the flow of coolant in a coolant circuit. Each tier may comprise coolant ports for connecting the coolant plates of that tier to an external coolant circuit. Alternatively, the coolant plates of different tiers could be connected internally within the enclosure, and a single set of coolant ports provided for the whole battery pack.

In one embodiment, the bottom panel incorporates one or more cooling plates. This may facilitate assembly and reduce the space requirements, thereby allowing a higher energy density to be achieved.

Corresponding methods may also be provided. Thus, according to another aspect of the disclosure there is provided a method of assembling an enclosure for a battery pack, the method comprising:
providing a plurality of surround frames;
supporting a plurality of battery cells on each surround frame;
applying a seal to at least one surround frame;
stacking one surround frame on another surround frame; and
using a plurality of fasteners to apply a force to the surround frames, thereby applying a pressure to the seal.

The tier stacking process may be substantially the same regardless of the number of tiers used. Therefore the same process and tooling can be deployed with minimal changes to manufacturing lines.

The method may further comprise manufacturing the surround frames using an extrusion process. For example, the method may comprise extruding a single continuous piece of material (such as aluminium), and then bending the material to form a surround frame. The method may further comprise connecting each end of the piece of material, for example, by welding. This may allow a strong and lightweight surround frame with the required stiffness to be produced using a readily available and inexpensive manufacturing process.

Features of one aspect of the disclosure may be provided with any other aspect. Any of the apparatus features may be provided as method features and vice versa.

### BRIEF DESCRIPTION OF THE DRAWINGS

Features of the present disclosure will now be described, purely by way of example, with reference to the accompanying drawings, in which:

FIG. 1 shows a previously considered battery pack system;

FIG. 2 is an exploded view of a battery pack in an embodiment of the disclosure;

FIG. 3 is an exploded view of parts of a battery pack enclosure in one embodiment;

FIG. 4 shows in more detail part of the battery pack enclosure that is bonded;

FIG. 5 shows a cross-sectional profile of an extruded piece used to form a surround frame;

FIG. 6 shows schematically a cross-section through part of an assembled battery pack;

FIGS. 7 to 16 illustrate a process of assembling a battery pack in one embodiment of the disclosure;

FIGS. 17A and 17B show in more detail a front of an upper tier and a lower tier respectively of a battery pack;

FIG. 18 shows a battery pack comprising a lower tier, a middle tier and an upper tier; and

FIG. 19 shows an exploded view of a battery pack in another embodiment of the disclosure.

### DETAILED DESCRIPTION

### Overview

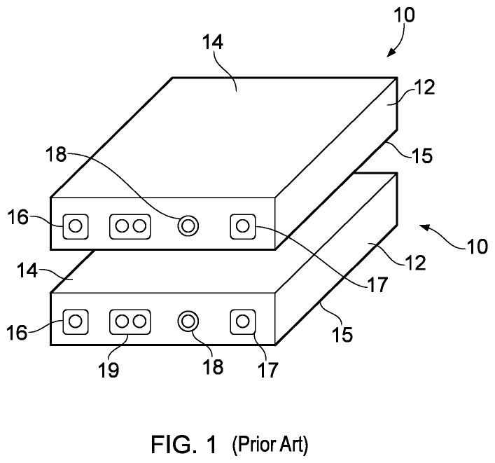

FIG. 1 shows a previously considered battery pack system. The battery pack system of FIG. 1 is designed to be used with electric and hybrid vehicles, particularly in high horsepower applications as buses, trucks, vans, construction equipment, and so forth, although other applications such as power generation are also contemplated.

Referring to FIG. 1, the battery pack system comprises two battery packs 10 stacked one on top of the other. Each battery pack 10 comprises a surround frame 12, a top panel 14 and a bottom panel 15. The surround frame 12, a top panel 14 and a bottom panel 15 house a plurality of battery cells along with cooling plates and a battery management system. The battery cells may be grouped into a plurality of battery modules. Each battery pack 10 also comprises a positive high voltage terminal 16, a negative high voltage terminal 17, a low voltage terminal 18, and coolant input and output ports 19. The high voltage terminals 16, 17, low voltage terminal 18 and coolant ports 19 are provided in the surround frame 12 and connect to the appropriate components inside the battery pack. In addition, other components such as a fuse, pressure vent and manual service disconnect (not shown) may be provided in the surround frame. The battery packs of FIG. 1 may be for example as disclosed in United Kingdom patent publication number GB 2605683 A, the subject matter of which is incorporated herein by reference.

In the arrangement of FIG. 1, the battery packs 10 are arranged to be stacked one on top of another. The battery packs are physically connected together, for example, using a plurality of bolts. High voltage and low voltage electrical connections are made to each battery pack via a junction box. The coolant input and output ports are connected to a cooling system to allow coolant to circulate inside the battery packs.

The battery pack system of FIG. 1 allows a number of battery packs to be stacked together in order to increase the total battery capacity. However, this results in an increased number of relatively high-cost components such as contactors and fuses and an increased number of connections for the customer. Furthermore, it may be difficult to consistently maintain structural strength due to relaxation of the bolts over time. In addition, the system may lack flexibility and may not fully optimise space.

In embodiments of the present disclosure, a tiered battery system is provided which is based on a modular design. The disclosed modular design allows either a single tier or multiple tiers of battery cells to be enclosed within the same enclosure.

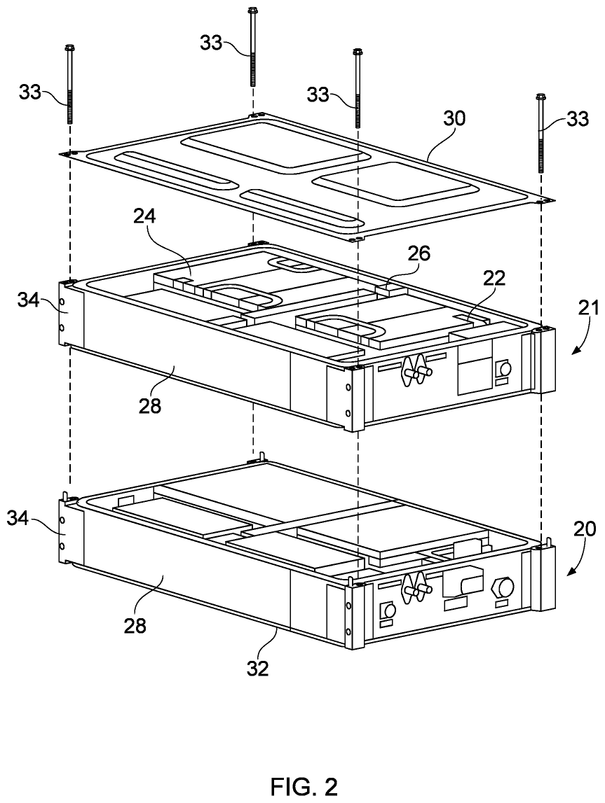

FIG. 2 is an exploded view of a battery pack in an embodiment of the disclosure. Referring to FIG. 2, the battery pack in this embodiment comprises a lower tier 20 and an upper tier 21. Each tier comprises a plurality of battery modules 22 which are electrically connected by busbars 24.

In the arrangement of FIG. 2, the battery modules 22 and other components of each tier are surrounded on four sides by a surround frame 28. Each surround frame 28 comprises four walls which form the front, rear and two sides of each tier. A cross member 26 extends between the two side walls of each surround frame 28. Corner gussets 34 are provided on each of the four corners of the surround frames. The corner gussets 34 include holes which are arranged to receive bolts 33. The battery modules 22 are mounted on the surround frame 28, which provides the main structural part of each tier. Each tier 20, 21 is self-supporting and capable of being stacked.

Each tier 20, 21 also comprises a battery management unit (not shown) which is used to manage charge and discharge of the battery modules 22, in cooperation with cell monitoring units inside the battery pack. The battery management unit may be either inside or outside the surround frame (or a combination of the two). If the battery management unit is outside the surround frame, the battery management unit communicates with the cell monitoring units through a low voltage terminal on the surround frame. If the battery management unit is inside the surround frame, a low voltage terminal in the surround frame is used to connect the battery management unit to an external battery management system. Other components such as cooling plates (not visible in FIG. 2) may also be provided within each tier.

In the arrangement shown in FIG. 2, the surround frame 28 in the upper tier 21 is stacked on top of the surround frame 28 in the lower tier 20, such that the walls of the surround frames 28 are aligned in a vertical direction (when the battery pack is placed on a horizontal surface). A top panel 30 is mounted on the top side of the surround frame 28 in the upper tier 21. Likewise, a bottom panel 32 is mounted on the underside of the surround frame 28 in the lower tier 20. However, no top panels or bottom panels are provided between the tiers. Thus, the top panel 30, the two surround frames 28 and the bottom panel 32 form a single enclosure which houses the two tiers of battery modules. A plurality of bolts 33 is used to secure the tiers 20, 21 together. In the arrangement shown, one bolt 33 is provided at each corner of the battery pack. The bolts 33 pass through the top panel 30 and the corner gussets 34 in each surround frame. In addition, two bolts (not shown) are provided centrally to connect the cross members 26 of each tier.

### Battery Pack Enclosure

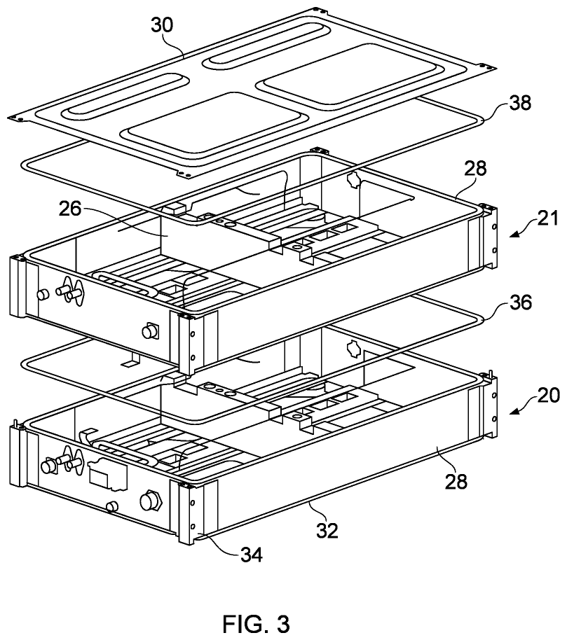

FIG. 3 is an exploded view of parts of the battery pack enclosure in one embodiment. Referring to FIG. 3, the battery pack enclosure comprises two surround frames 28, a top panel 30 and a bottom panel 32. The two surround frames 28 are stacked one on top of the other such that their walls are aligned. A seal 36 is provided between the two surround frames 28. The seal may be a filament semi-set seal. The top panel 30 is attached to the surround frame 28 in the upper tier 21 using a structural adhesive 38. In addition, bolts (not shown in FIG. 3) are provided at each corner and centrally in the manner shown in FIG. 2.

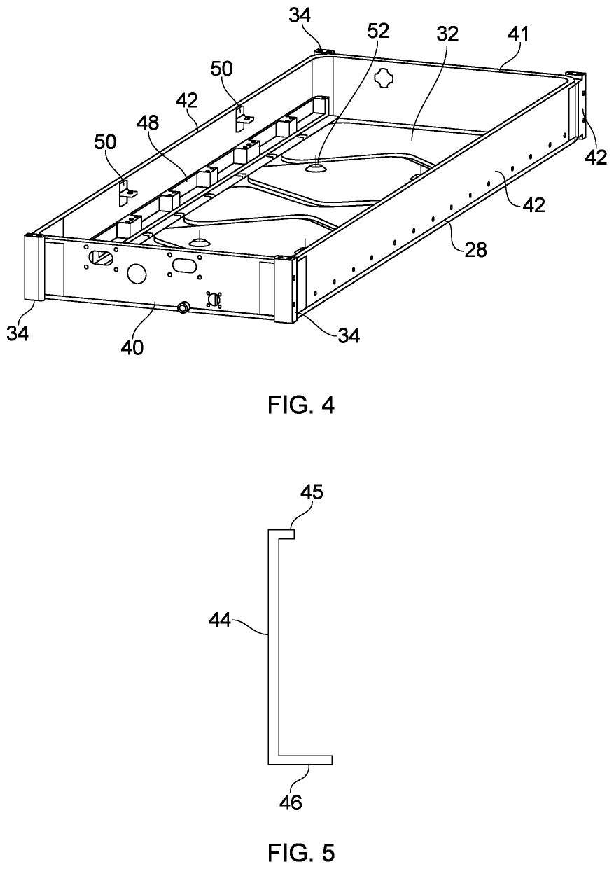

FIG. 4 shows in more detail a lower part of the battery pack enclosure. Referring to FIG. 4, the lower part of the battery pack enclosure comprises surround frame 28 and bottom panel 32. The surround frame 28 comprises front wall 40, rear wall 41 and two side walls 42. The surround frame 28 in this embodiment is made from extruded aluminium. The bottom panel 32 may be made from any suitable material such as metal or composite.

Aluminium extrusion is a process by which an aluminium alloy is forced through a die with a specific cross-sectional profile. The extruded material is typically produced as a single straight piece with the profile of the die. In the present embodiment, as part of the manufacturing process, the surround frame 28 is extruded as single straight piece with the desired cross-sectional profile. The extruded piece is then bent into a rectangular shape with a front wall 40, rear wall 41 and two side walls 42. Once the extruded piece has been bent into shape, its ends are welded together to produce the surround frame 28. This allows a strong and lightweight surround frame to be produced with a minimal number of joints, using a readily available and inexpensive manufacturing process.

FIG. 5 shows a cross-sectional profile of the extruded piece used to form the surround frame 28 of FIG. 4. Referring to FIG. 5, the extruded piece has a C-shaped (or rotated U-shaped) cross-section, with an upright wall 44, a top lip 45 and a bottom lip 46. In this embodiment, the top lip 45 is smaller than the bottom lip 46. The extruded piece is initially a single straight piece which is then stretch bent into a rectangular shape to produce the surround frame 28. Use of the profile shown in FIG. 5 can facilitate production of the surround frame by extrusion.

If desired, the corners of the extruded piece may be machined prior to bending, in order to facilitate the bending process. For example, some machining may be performed at each corner to make a symmetrical section that is easier to bend. The resultant reduction in flange width may be compensated for by using corner gussets as explained below.

Referring back to FIG. 4, once the surround frame 28 has been produced, corner gussets 34 are added to each of the four corners. The corner gussets may be made from any appropriate material, for example, a metal such as aluminium or steel. The corner gussets 34 extend around the corners of the surround frames 28 and help to improve their stiffness. The corner gussets 34 have two arms, which each arm being attached to a respective wall of the surround frame. Thus, the corner gussets 34 have a substantially L-shaped profile when viewed from above. The corner gussets 34 also have central portions with vertical bolt holes. The corner gussets 34 are riveted and/or bonded onto the outside of the surround frame. The corner gussets 34 strengthen the surround frame 28 and provide holes through which bolts 33 can pass in order to connect the upper tier to the lower tier in the assembled battery pack. The corner gussets may also facilitate manufacture of the surround frame, by compensating for any reduction in flange width which may have provided to facilitating bending of the extruded piece.

In the arrangement of FIG. 4, a cell support rail 48 is also provided on each side of the surround frame 28. The cell support rails may be made from any appropriate material, for example, a metal such as aluminium or steel. Each cell support rail 48 is located on the lower side of a side wall 42, inside the surround frame, between the upright wall 44 and the bottom lip 46 of the cross-sectional profile. Each cell support rail 48 extends substantially along the length of the surround frame 28. The cell support rails 48 are riveted and/or bonded onto the inside of the surround frame 28. The cell support rails 48 are used to attach the battery modules to the surround frame. The cell support rails also provide sectional stiffness to the surround frame.

The corner gussets and cell support rails are structurally bonded to the surround frame with adhesive and either with or without rivets.

In addition, brackets 50 are attached to the inside of the surround frame 28. The brackets 50 are used to attach cross members (not shown in FIG. 4) to the surround frame 28. The brackets 50 are riveted and/or bonded onto the inside of the surround frame 28. The brackets may be made from any appropriate material, for example, a metal such as aluminium or steel.

The bottom panel 32 is attached to the underside of the surround frame 28. In this embodiment, the bottom panel 32 is attached to the lower lip 46 of the cross-sectional profile using a structural adhesive. Bolts 52 are provided which pass through the bottom panel 32. The bolts 52 are used to attach the bottom panel 32 to the cross members.

Holes are also provided in the surround frame 28 for various connectors and other components. The holes may be stamped or machined in the surround frame 28 either prior to bending or after bending into shape.

Referring back to FIG. 3, a seal 36 is provided between the surround frames 28 of the lower tier 20 and the upper tier 21. The seal in this embodiment is formed from a pressure sensitive adhesive. Pressure-sensitive adhesives (PSAs) are a type of non-reactive adhesive which form a bond when pressure is applied. In one embodiment, the seal is made from a synthetic elastomer such as a polyurethane, although other materials such as polyacrylate or silicone resins could be used instead. Suitable pressure-sensitive adhesives are commercially available and manufactured, for example, by the 3M™ company. In the assembled battery pack, pressure is applied to the seal 36 using the bolts 33. This ensures that a seal between the two tiers is maintained when the battery pack is in use.

Still referring to FIG. 3, a structural adhesive is used to attach the top panel 30 to the surround frame 28 in the upper tier 21. A structural adhesive is one that can be used to produce a load-bearing joint. Typically, a structural adhesive is used for engineering applications where joints need to have lap shear strengths of greater than, for example, 1 MPa or 10 MPa. A high Youngs modulus (for example, above about 1 GPa) is also beneficial for stiffness attributes of the battery enclosure. Structural adhesives are typically available in three main chemistries: epoxies, urethanes and acrylics. In one embodiment, an acrylic adhesive is used to attach the top panel 30 to the surround frame 28. However, any other suitable adhesive could be used instead. For example, any type of adhesive comprising epoxies, toughened acrylics, polyurethanes, cyanoacrylates, anaerobics, phenolics or vinyl acetates, or any other suitable adhesive, may be used instead or as well.

In general, the type of structural adhesive is chosen to provide sufficient adhesive strength to ensure that, in use, loads can be transferred though the joint without the joint becoming compromised. However, in some embodiments, the top panel 30 is designed to be removable from the surround frame 28 in order to service the battery pack. In this case, the choice of adhesive is a balance between achieving the desired joint strength, while allowing the panel to be lifted from the surround frame upon application of a pulling force above a certain value (for example, above approximately 50 N, 100 N or 150 N). Suitable structure adhesives are supplied by the 3M™ company. Further details of a top panel attachment and removal process are disclosed in United Kingdom patent publication number GB 2605683 A, the subject matter of which is incorporated herein by reference.

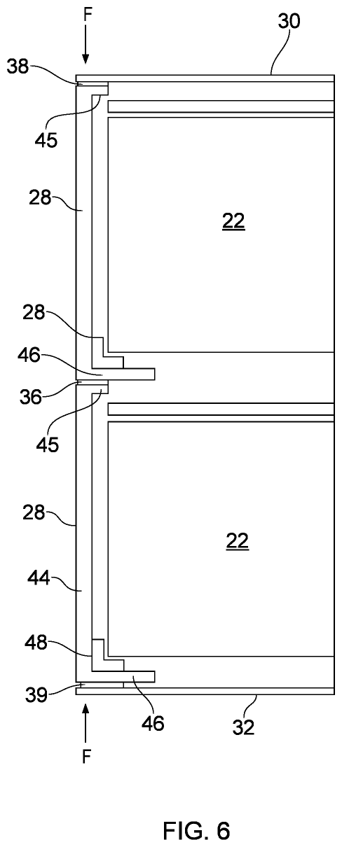

FIG. 6 shows schematically a cross-section through part of the assembled battery pack. Referring to FIG. 6, the battery pack comprises two surround frames 28, a top panel 30 and a bottom panel 32. The surround frames 28 are stacked one on top of the other, such that the side walls of the surround frames 28 are aligned in a vertical direction. The upper surround frame 28 is attached to the lower surround frame 28 using a pressure sensitive adhesive 36. The top panel 30 is attached to the upper surround frame 28 using a structural adhesive 38. The bottom panel 32 is attached to the lower surround frame 28 using structural adhesive 39. Each surround frame comprises a module support rail 48. The module support rails are substantially L-shaped in cross-section and sit at the lower end of the surround frames between the side wall and the lower lip. The battery modules 22 are mounted on the cell support rails 48.

In the arrangement shown, the surround frames 28 are designed to ensure that enough compression is applied to the pressure sensitive adhesive 36 to allow it to set. In particular, the bolts 33 (see FIG. 2) are tightened to apply a force F to the surround frames. The force may be, for example, between about 20 N and 100 N (or more) depending on the size of the battery pack. For example, the force may be such as to exert a pressure of around 1,000 to 5,000 N/m² on the pressure sensitive adhesive. However, it will be appreciated that these values are given by way of example only, and other values could be used instead depending on the circumstances. The force is transferred through the corner gussets 34 via shear force to the walls of the surround frames. Since the bolts are at the corners of the battery pack enclosure, they are substantially aligned with the walls of the surround frame in a longitudinal direction. The walls of the surround frame are thus orientated in the same direction as the force and are able to transfer the force to the seal 36 without any significant deflection or bending. This allows enough compression to be applied to the pressure sensitive adhesive 36 to allow it to set, and to remain set during normal operation of the battery pack, while allowing the use of relatively thin walls in the surround frame and a minimal number of fasteners.

In the battery pack arrangement described above, during assembly, the battery modules 22 are inserted into the respective surround frames 28 from above. It is therefore necessary for the battery modules 22 to be able to clear the top lip 45 of the respective surround frames 28 as they are inserted.

In the arrangement shown in FIG. 6, the seal 36 is located between the top lip 45 of the lower surround frame 28 and the bottom lip 46 of the upper surround frame. The top lip 45 extends inwards by an amount sufficient to provide a surface for the seal 36. However, the top lip 45 does not need to accommodate any bolts. Thus, the top lip 45 can be smaller than would be the case if it were used to bolt the two surround frames together. This can allow the side wall 44 of the surround frame 28 in the lower tier to be closer to the battery modules 22 than would otherwise be the case (since the battery modules 22 need to clear the top lip 45 as they are inserted). This allows more of the internal space to be used for cell packaging, thereby increasing the energy density of the battery pack. Furthermore, this arrangement does not require the use of an outside flange or multiple peripheral bolts, thereby optimising the total space requirements of the battery pack enclosure.

The structural adhesive 38 is provided between the top lip 45 of the upper surround frame 28 and the top panel 30. The top lip 45 extends inwards by an amount sufficient to provide a surface for the adhesive 38. However, the top lip 45 does not need to accommodate any bolts. Thus, the top lip 45 can be smaller than would be the case if it were used to bolt the top panel to the surround frame. This can allow the side wall 44 of the surround frame 28 in the upper tier to be closer to the battery modules 22 than would otherwise be the case. Thus, this also allows more of the internal space to be used for cell packaging and avoids the need for an outside flange. This may be key to optimising the available packaging space, which may be advantageous particularly in vehicle applications.

The structural adhesive 39 is provided between the bottom lip 46 of the lower surround frame 28 and the bottom panel 32. However, as the battery modules are inserted from above, the bottom lip 46 can extend somewhat further inwards than the top lip. This can allow the bottom lip 46 to provide support for the cell support rail 48.

The arrangement described above allows two or more tiers of battery modules to be provided in a single enclosure. The enclosure is held together using four corner bolts and bolts between the cross members of adjacent tiers. A polyurethane seal that sets when compressed is provided between the surround frames. The stiffness of the frame ensures enough compression to allow the seal to set. This allows the enclosure to be provided without an external flange and without the need for peripheral bolts, which helps to minimise the number of bolts and the outside dimensions of the enclosure. Internal bolts are nested underneath the cross members to avoid losing space. The corner gussets transfer load to the surround frame via shear force, minimising local displacement in the frame. The cell support rail provides sectional stiffness to the frame, further facilitating the transfer of force to the seal. The surround frames are made from continuous stretch bent extruded aluminium. This allows the frames to be lightweight, strong and inexpensive, and minimises the number of joints required. In particular, the number of welded joints which could cause heat distortion is minimised. This helps to minimise the number of areas that could be a leak risk.

### Assembly

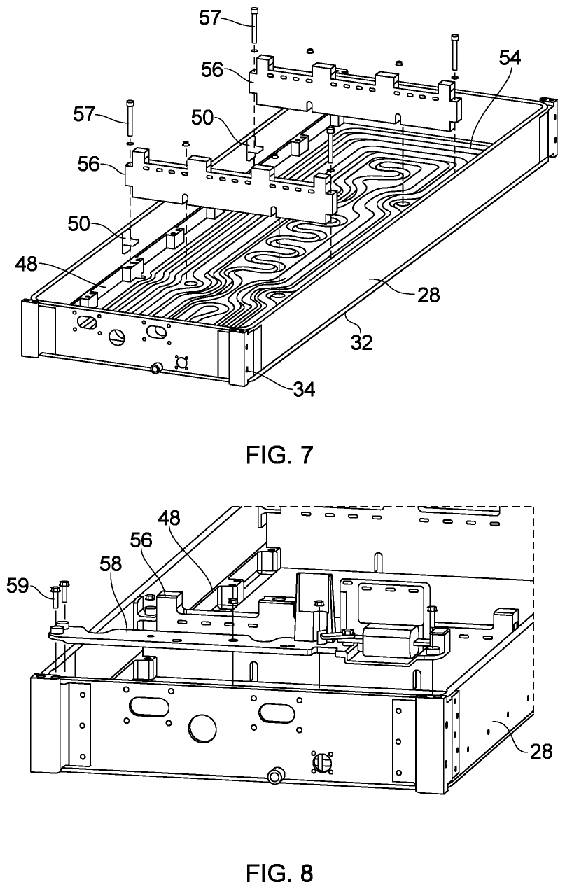

A process of assembling a battery pack in one embodiment of the disclosure will now be explained with reference to FIGS. 7 through 16.

FIG. 7 shows a lower part of the battery pack in a partially assembled state. Referring to FIG. 7, the surround frame 28 in the lower tier 20 is shown. A cooling plate 54 is provided inside the surround frame 28. The cooling plate 54 sits underneath the battery modules in the assembled battery pack and is used to cool the battery modules. If desired, the cooling plate 54 could be incorporated into the bottom panel 32, although it could also be a separate component. Also shown in FIG. 7 are cross members 56. The cross members 56 are lowered into the surround frame 28 and attached to the brackets 50 using bolts 57. When in place, the cross members 56 extend between the side walls of the surround frame 28. The cross members help to provide structural strength to the battery pack and help prevent deflection of the surround frame walls, for example, when experiencing internal pressure increases that may be seen in thermal propagation events.

FIG. 8 illustrates a subsequent stage of the assembly process. Referring to FIG. 8, a front bracket 58 is lowered into the surround frame and then attached to the cell support rails 48 using bolts 59. The front bracket 58 is used to support electrical distribution components (such as a cell monitoring board) and other components of the lower tier of the battery pack.

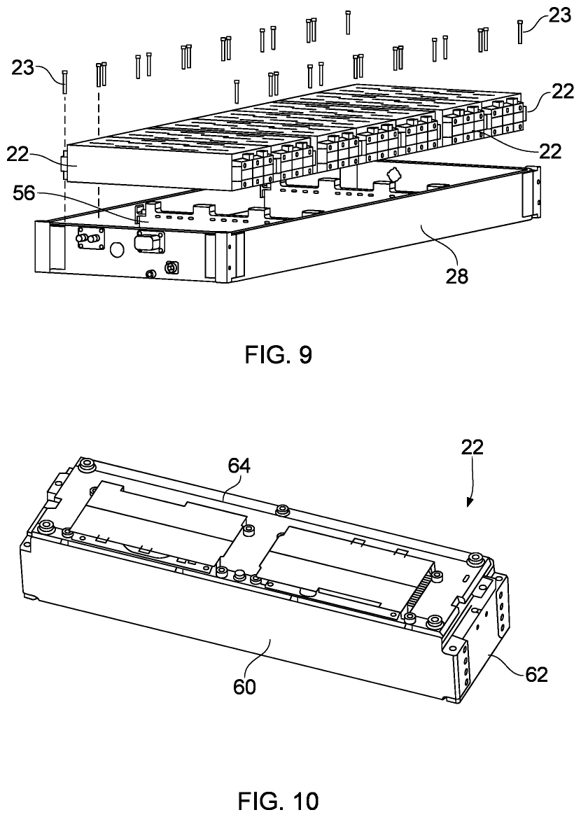

FIG. 9 illustrates installation of battery modules into the lower tier of the battery pack. Referring to FIG. 9, in this embodiment seven battery modules 22 are provided in each tier of the battery pack. The battery modules 22 are transverse orientated, that is, they run from side to side in the battery pack. The battery modules 22 are lowered into the surround frame 28 from above, and then mounted on the cell support rails 48 using bolts 23. Once inserted, the battery modules 22 span between the two cell support rails 48 and sit on top of the cooling plate 54. The battery modules 22 are then electrically connected in the appropriate series/parallel configuration using busbars, to achieve the target voltage and/or energy for the lower tier of the battery pack.

FIG. 10 shows in more detail parts of a battery module. Referring to FIG. 10, in this example the battery module 22 comprises a plurality (for example, eighteen) prismatic cells stacked together side-by-side. The prismatic cells are contained within a module housing 60. The module housing 60 runs around the outside of the cells and is used to physically hold the cells in place. The module housing 60 includes an expansion plate 62 which allows for a small amount of expansion of the cells when in use. A laminated busbar 64 is provided on top of the cells. The busbar 64 electrically connects the cells in the module in series and/or parallel to achieve the target module voltage. A cell monitoring board is integrated with the battery module 22 to monitor cell charge and other aspects of cell operation.

It will be appreciated that the battery modules are described above by way of example only, and other types of battery module could be used instead. For example, the battery modules could use a different type of cell, such as prismatic or cylindrical, and a different number of cells could be provided within in module. Furthermore, a different number of battery modules could be used, and each battery module could have a different configuration from that shown. In other embodiments, the battery cells may be inserted directly into the battery pack without being grouped into modules.

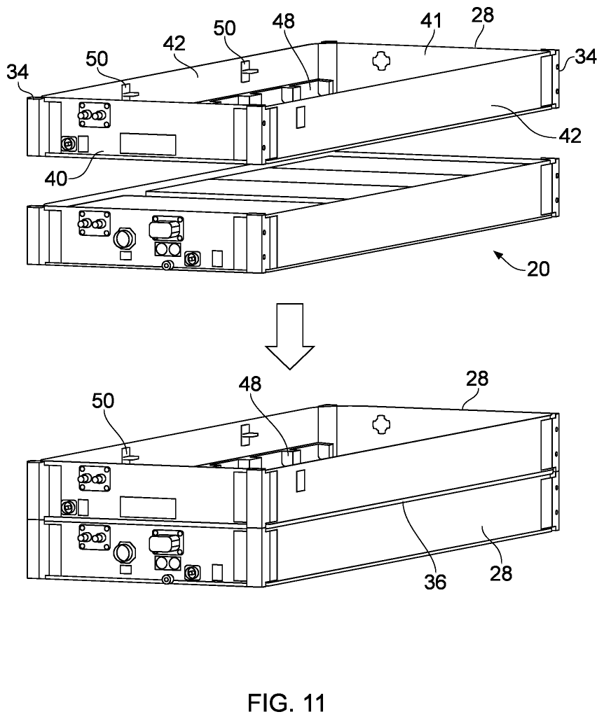

FIG. 11 illustrates assembly of the surround frame in the upper tier of the battery pack to the lower tier. Referring to FIG. 11, the surround frame 28 in the upper tier comprises a front wall 40, rear wall 41 and two sides walls 42 which are substantially the same as the corresponding walls in the surround frame in the lower tier. The surround frame 28 in the upper tier is made from extruded aluminium, in the same way as the surround frame in the lower tier. Corner gussets 34 are provided on each corner of the surround frame. A cell support rail 48 is provided on each side of the surround frame 28. In addition, brackets 50 are attached to the inside of the surround frame 28. The corner gussets 34, cell support rails 48 and brackets 50 are substantially the same as the corresponding parts on the surround frame of the lower tier.

Before the surround frame 28 in the upper tier is assembled to the lower tier, a seal is applied to one or both of the surround frames. For example, in one embodiment the seal is applied to the top lip 45 of the surround frame 28 in the lower tier 20. The seal is a pressure sensitive adhesive seal. In one embodiment, a polyurethane sealant is applied hot and compressed when the frames are bolted together.

Once the seal has been applied, the surround frame in the upper tier is assembled to the lower tier. In the assembled battery pack, bolts 33 are provided at each corner of the battery pack in the manner shown in FIG. 2. In addition, bolts are provided between cross members 56 of each tier. The bolts ensure that sufficient pressure is applied to the pressure sensitive adhesive seal to maintain the seal during operation of the battery pack.

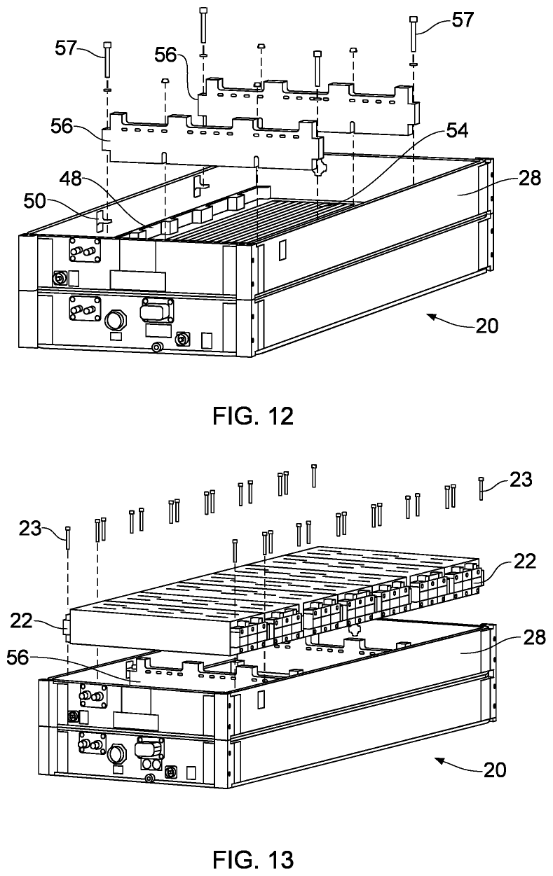

FIG. 12 illustrates assembly of cross members to the surround frame in the upper tier. Referring to FIG. 12, a cooling plate 54 is provided inside the surround frame 28 in the upper tier. The cooling plate 54 sits underneath the battery modules in the upper tier and is used to cool the battery modules. The cross members 56 are attached to the brackets 50 using bolts 57. In addition, four bolts are used to connect the cross members 56 in the upper tier to the cross members in the lower tier. The cooling plate 54 and the cross members 56 are substantially the same as the corresponding parts in the lower tier of the battery pack. Additionally, a bracket (not shown) is attached to the cell support rails 48 using bolts, in a similar way to the bracket 58 in the lower tier shown in FIG. 8. The bracket is used to support a cell monitoring board and other components of the upper tier of the battery pack.

FIG. 13 illustrates installation of battery modules into the upper tier of the battery pack. Referring to FIG. 13, in this embodiment seven battery modules 22 are provided in the upper tier. The battery modules 22 in the upper tier are substantially the same as those in the lower tier. The battery modules 22 are transverse orientated and are mounted on the cell support rails 48 using bolts 23. Once inserted, each of the battery modules 22 sits on top of the cooling plate 54. The battery modules 22 are then electrically connected in the appropriate series/parallel configuration using busbars, to achieve the target voltage for the upper tier of the battery pack.

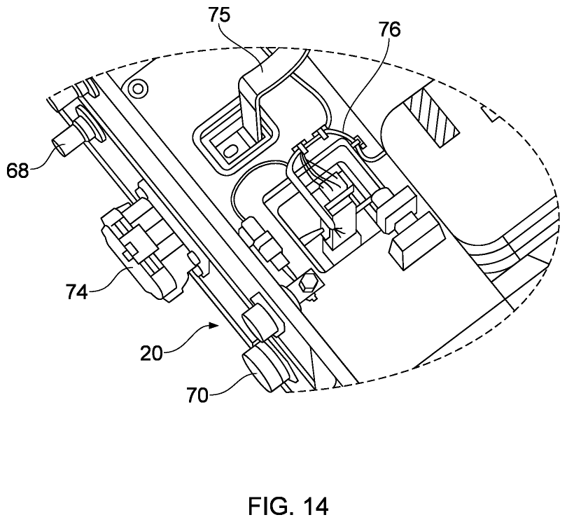

FIG. 14 shows electrical connections between the upper tier 21 and the lower tier 20 of the battery pack in one embodiment. Referring to FIG. 14, a high voltage busbar 75 is used to connect the positive end of the series/parallel configuration of battery modules 22 in the upper tier 21 to the negative end of the series/parallel configuration of battery modules 22 in the lower tier 20 (or vice versa). A manual service disconnect 74 in the lower tier 20 is configured so that it can disconnect the battery modules 22 in both tiers 20, 21. A low voltage cable 76 is provided to connect the cell monitoring board and other low voltage components in the upper tier 21 to the cell monitoring board and other low voltage components in the lower tier 20.

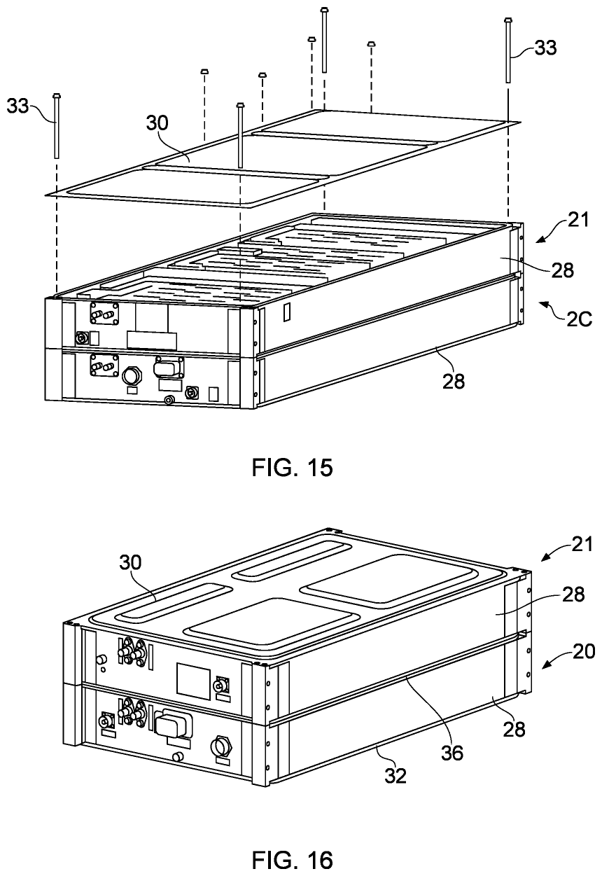

FIG. 15 illustrates assembly of the top panel to the battery pack. Referring to FIG. 15, the top panel 30 is mounted on the top side of the surround frame 28 in the upper tier 21. In this embodiment, the top panel 30 is attached to the upper lip 45 of the cross-sectional profile using a structural adhesive. In addition, the bolts 33 pass through the top panel 30 and the corner gussets 34 in each surround frame. The top panel 30 may be made from any suitable material such as metal or carbon fibre.

Prior to attachment of the top panel 30, a structural adhesive is applied to top panel or the surround frame, or both. For example, in one embodiment, the structural adhesive is applied to the top lip 45 of the surround frame 28 in the upper tier 21. This may be done, for example, in the manner disclosed in United Kingdom patent publication number GB 2605683 A, the subject matter of which is incorporated herein by reference. The top panel 30 is then assembled to the surround frame, and pressure applied until a bond has formed.

FIG. 16 shows the assembled battery pack. In this embodiment, the two surround frames 28 together with the top panel 30 and bottom panel 32 form a single enclosure (cavity) which accommodates two tiers of battery modules.

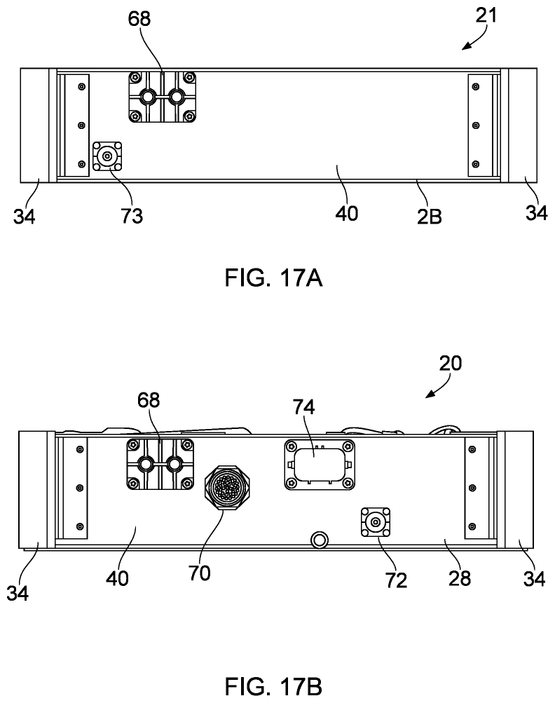

FIGS. 17A and 17B show in more detail the front of the upper tier and lower tier respectively. Referring to FIG. 17A, the front wall 40 of the surround frame 28 in the upper tier 21 is provided with coolant ports 68 and negative high voltage terminal 73. The coolant ports 68 are connected to the cooling plate 54 in the upper tier 21 using hoses. The negative high voltage terminal 73 is electrically connected to the negative end of the series/parallel configuration of battery modules 22 in the upper tier. However, rather than being connected to a positive high voltage terminal, the positive end of the series/parallel configuration of battery modules 22 in the upper tier is connected to the negative end of the series/parallel configuration of battery modules 22 in the lower tier 20 using the high voltage busbar 75 shown in FIG. 14. Furthermore, the low voltage components in the upper tier 21 are connected to the low voltage components in the lower tier 20 using the low voltage cable 76 shown in FIG. 14. Thus, in this embodiment, the upper tier 21 does not include a low voltage terminal, a positive high voltage terminal or a manual service disconnect.

Referring to FIG. 17B, the front wall 40 of the surround frame 28 in the lower tier 20 is provided with coolant ports 68, low voltage terminal 70, positive high voltage terminal 72 and a manual service disconnect (MSD) 74. The coolant ports 68 are connected to the cooling plate 54 in the lower tier 20 using hoses. The low voltage terminal 70 is electrically connected to the cell monitoring board and other low voltage components of the lower tier 20. The positive high voltage terminal 72 is electrically connected to the positive end of the series/parallel configuration of battery modules 22. However, rather than being connected to a negative high voltage terminal, the negative end of the series/parallel configuration of battery modules 22 is connected to the positive end of the series/parallel configuration of battery modules 22 in the upper tier using the high voltage busbar 75 shown in FIG. 14. Thus, in this embodiment, a negative high voltage terminal is not provided in the lower tier of the battery pack.

It will thus be appreciated that, in comparison to the arrangement shown in FIG. 1, the battery pack design described above can reduce the number of high-cost components, such as contactors and fuses, and reduce the number of connections for the end user.

Of course, it will be appreciated that the high voltage terminals 72, 73 could be provided the other way around, or both in one surround frame. Furthermore, the low voltage terminal 70 and/or the manual service disconnect 74 could be provided in either surround frame, or both. In addition, if desired, the coolant circuits of the two tiers could be connected internally, and a single set of inlet/outlet ports provided.

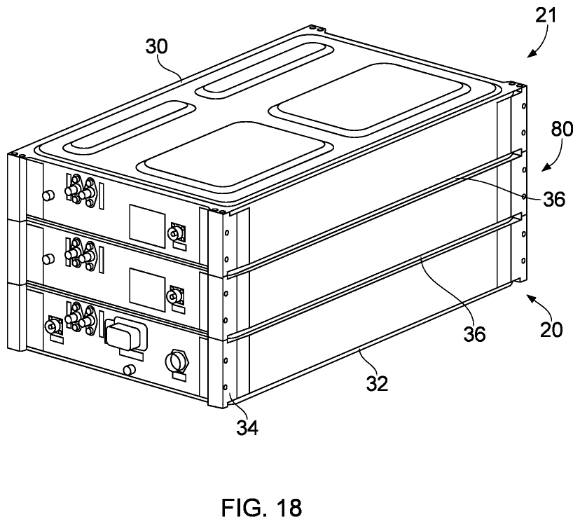

If desired, a battery pack comprising three or more tiers could be provided in a similar way. For example, FIG. 18 shows a battery pack comprising a lower tier 20, an upper tier 21 and a middle tier 80. The top panel 30 is attached to the surround frame in the upper tier 21 and the bottom panel 32 is attached to the surround frame in the lower tier 20, in a similar way to that described above. In this embodiment, a seal 36 is provided between each adjacent tier of the battery pack. Pressure is applied to the seals 36 using bolts which pass through the corner gussets 34 of each of the three tiers. In general, any arbitrary number of tiers, such as one, two, three, four, five or more, could be provided.

### Servicing

During use of a battery pack, it is possible for the cells to become damaged or otherwise compromised. Furthermore, battery packs for electric vehicle applications tend to degrade during use and are typically designed for approximately ten years of life. When the battery packs no longer meet electric vehicle performance standards, which typically include maintaining 80% of total usable capacity, they may need to be replaced. However, the battery packs may still be usable in second life applications, which are typically stationary applications such as power generation.

An advantage of using a battery pack with a plurality of battery modules is that individual modules can be serviced or replaced should they fail without the need to replace the whole battery pack. This is typically achieved by removing the top panel to gain access to the battery modules. In the case of a top panel which is attached to the frame with bolts, the top panel can be removed by unscrewing the bolts and prising off the top panel. However, if the top panel is attached to the frame using adhesive, then it may not be possible to remove the top panel in this way.

In one embodiment, the top panel 30 is arranged to be removed from the surround frame using a torsion bar. The torsion bar is attached to one corner of the top panel, and then rolled across the top of the battery pack. A perpendicular pulling force is applied progressively to the top panel as the bar rotates. This overcomes the strength of the adhesive joint, causing the top panel to be lifted off of the surround frame. This process resembles the removal of the lid of a sardine can using a key. The top panel removal process may be, for example, as described in United Kingdom patent publication number GB 2605683 A, the subject matter of which is incorporated herein by reference.

The upper surround frame may be disconnected from the lower surround frame by undoing the bolts 33, and pulling away the seal 36. The use of a pressure sensitive adhesive to form the seal 36 can allow the seal to be easily removed once the pressure has been removed by releasing the bolts. This can allow the seal to be removed while the surround frames are still stacked. The upper tier can then be removed from the lower tier, allowing access to the battery modules in the lower tier. This therefore facilitates servicing of the battery pack.

When the battery pack is to be returned to service, a seal is applied to one (or both) of the surround frames 28, and the surround frames are brought together and attached in the way described above. A new top panel is attached to the surround frame in the upper tier using adhesive, in the way described above. The top panel is typically a relatively low-cost component, compared to other parts of the battery pack such as the battery modules, and thus the need to provide a new top panel does not add significantly to the cost of servicing the battery pack.

The arrangements described above provide an enclosure design that can be expanded or shrunk depending on end user requirements via the use of minimal bolted joints and a sealing material to retain structural rigidity and sealing while maximizing serviceability and production efficiency. This can allow battery pack capacity to be increased without multiple single packs which would increase the complexity of the control hardware, increase the number of high-cost components such as contactors and fuses, and increase the number of connections for the end user. Each tier of the structure is self-supporting and capable of being stacked easily to meet structural requirements. The sectional stiffness is designed to minimize the number of fasteners required to optimize the design for production and servicing.

The basic enclosure design is common between tiers with regards to the mechanical interface conditions. This results in reduced complexity of the pack, which allows for reduced production time and servicing when both assembling and disassembling. Another benefit is that the tier stacking process remains essentially unchanged regardless of number of tiers used, therefore the same or similar processes and tooling can be deployed with minimal changes to manufacturing lines.

### Cell-to-Pack

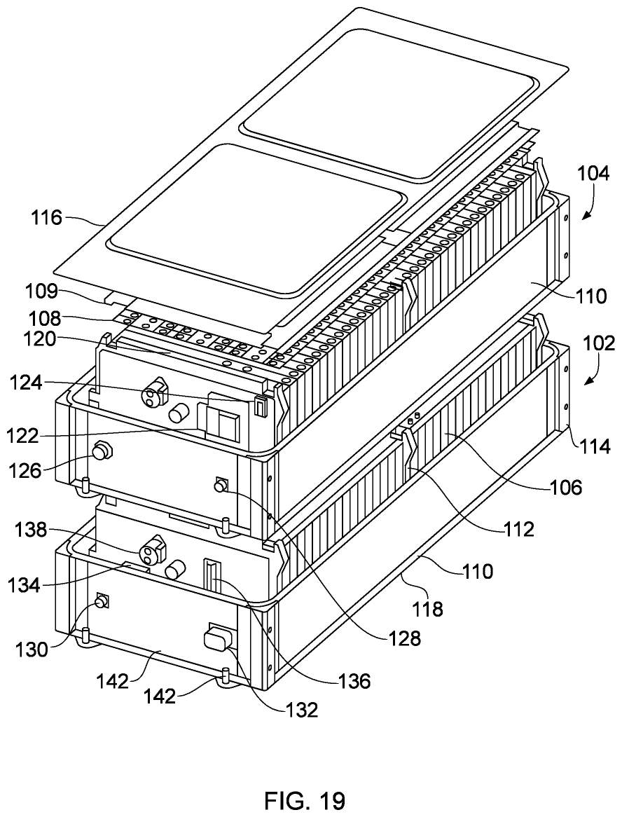

FIG. 19 shows an exploded view of a battery pack in another embodiment of the disclosure. Referring to FIG. 19, the battery pack comprises lower tier 102 and upper tier 104. Each tier 102, 104 comprises a plurality of battery cells 106 which are electrically connected by busbars 108 and covered by cell covers 109. The battery cells 106 and other components of each tier are surrounded on four sides by a surround frame 110. Each surround frame 110 comprises four walls which form the front, rear and two sides of each tier. A cross member 112 extends between the two side walls of each surround frame 110. Corner gussets 114 are provided on each of the four corners of the surround frames. The corner gussets 114 include holes which are arranged to receive bolts. The battery cells 106 are mounted on the surround frame 110, which provides the main structural part of each tier. As in the previous embodiments, each tier 102, 104 is self-supporting and capable of being stacked.

In the arrangement shown in FIG. 19, the surround frame in the upper tier 104 is stacked on top of the surround frame in the lower tier 102, such that the walls of the surround frames 110 are aligned in a vertical direction. A top panel 116 is mounted on the top side of the surround frame in the upper tier 104. Likewise, a bottom panel 118 is mounted on the underside of the surround frame in the lower tier 102. However, as in previous embodiments, no top panels or bottom panels are provided between the tiers. Thus, the top panel 116, the two surround frames 110 and the bottom panel 118 form a single enclosure which houses the two tiers of battery cells. The surround frames 110, top panel 116 and bottom panel 118 may be substantially in the forms described above in the previous embodiments. However, if desired their sizes may be adjusted to correspond to the sizes of the battery cells and the number of battery cells.

In the arrangement of FIG. 19, the battery cells are mounted directly into the battery pack, without being grouped into modules. The battery cells are transverse orientated, that is, they run from side to side in the surround frame. Each surround frame is provided with two cell support rails (not visible in FIG. 19) which may be the same as or similar to the cell support rails described above. Each battery cell is mounted on and spans between the two cell support rails.

In the arrangement shown, each tier 102, 104 comprises a cell monitoring board 120 which is used to monitor the operation of the battery cells in that tier. The cell monitoring boards 120 are connected to a battery management unit 122. In this embodiment, a single battery management unit is provided for both tiers. Since the battery management unit tends to be an expensive component, this can help reduce the overall cost of the battery pack. The battery management unit 122 is located inside the enclosure, and electrical connections are made inside the enclosure between the battery management unit 122 and the cell monitoring board 120 in each tier. The battery management is also connected to sensors 124 which sense internal parameters such as temperature and/or pressure. The battery management unit is connected to a low voltage port 126. Thus, in this embodiment, a single low voltage port 126 is provided for both tiers of the battery pack.

Also shown in FIG. 19 are a negative high voltage terminal 128, positive high voltage terminal 130, manual service disconnect 132, fuse 134 and pre-charge relay 136. The cells in each tier are electrically connected in series and/or parallel using contactors 138, so that only a single negative high voltage terminal 128, positive high voltage terminal 130, manual service disconnect 132, fuse 134 and/or pre-charge relay 136 need be provided.

In the arrangement of FIG. 19, a cooling plate is provided under the battery cells in each tier. An input port 140 is used to introduce coolant into the cooling plates, and an output port 142 is used to carry coolant out of the cooling plates. In this embodiment, the cooling plates in each tier are connected inside the enclosure. Thus, only a single input port 140 and output port 142 need be provided.

Embodiments of the disclosure have been described above by way of example only, and modifications in detail can be made. For example, although the battery pack described above is in the shape of a rectangular cuboid, other shapes could be used instead. Furthermore, other materials and processes from those described could be used to produce the battery pack. Various other modifications will be apparent to one skilled in the art within the scope of the claims.

1. A battery pack enclosure comprising:
a top panel;
a bottom panel; and
a plurality of surround frames, each surround frame arranged to support a plurality of battery cells,
wherein the surround frames are stacked, and
a seal is provided between two adjacent surround frames.

2. The battery pack enclosure of claim 1, wherein the seal comprises a pressure sensitive adhesive.

3. The battery pack enclosure of claim 1, wherein the seal is removeable while the surround frames are stacked.

4. The battery pack enclosure of claim 1, further comprising a plurality of fasteners arranged to urge the two adjacent surround frames together.

5. The battery pack enclosure of claim 4, wherein a fastener is provided at each corner of the battery pack enclosure.

6. The battery pack enclosure of claim 1, wherein the two adjacent surround frames are connected without the use of multiple peripheral fasteners.

7. The battery pack enclosure of claim 1, wherein the surround frames are formed from single continuous bent extrusions.

8. The battery pack enclosure of claim 1, wherein each surround frame is at least partially open on two sides.

9. The battery pack enclosure of claim 1, wherein each surround frame comprises a plurality of walls, and each wall comprises a top lip and a bottom lip.

10. The battery pack enclosure of claim 1, wherein the surround frames comprise corner gussets.

11. The battery pack enclosure of claim 10, wherein the corner gussets are arranged to receive fasteners which fasten the two adjacent surround frames together.

12. The battery pack enclosure of claim 1, wherein each surround frame comprises a plurality of cell support rails on which the battery cells can be mounted.

13. The battery pack enclosure of claim 1, wherein the top panel and bottom panel are attached to the surround frames with adhesive.

14. A battery pack comprising:
a plurality of battery cells arranged in tiers; and
a battery pack enclosure, wherein the battery pack enclosure comprises:
a top panel;
a bottom panel; and
a plurality of surround frames, each surround frame supporting a tier of battery cells,
wherein the surround frames are stacked, and
a seal is provided between two adjacent surround frames.

15. The battery pack of claim 14, wherein each surround frame comprises a plurality of cell support rails and the battery cells are mounted on the cell support rails.

16. The battery pack of claim 14, further comprising at least one cross member running between two walls of each surround frame, and at least one fastener which fastens cross members of adjacent tiers.

17. The battery pack of claim 14, wherein the battery cells in one tier are electrically connected to the battery cells in another tier inside the battery pack enclosure.

18. The battery pack of claim 17, wherein a positive terminal for the battery pack is provided in one tier and a negative terminal for the battery pack is provided in another tier.

19. The battery pack of claim 14, wherein each tier comprises a low voltage component, and a low voltage component in one tier is electrically connected to a low voltage component in another tier inside the battery pack enclosure.

20. A method of assembling an enclosure for a battery pack, the method comprising:
providing a plurality of surround frames;
supporting a plurality of battery cells on each surround frame;
applying a seal to at least one surround frame;
stacking one surround frame on another surround frame; and
using a plurality of fasteners to apply a force to the surround frames, thereby applying a pressure to the seal.
